(19) United States
(12) Patent Application Publication
(10) Pub. No.: US 2018/0324930 A1
(43) Pub. Date: Nov. 8, 2018

(54) WALL SWITCH BASE OF AN ELECTRIC LIGHT

(71) Applicants: WEN-BIN CHEN, Taipei City (TW); BANDRICH, INC., Taipei City (TW)

(72) Inventors: CHING-HSIUNG LEE, NEW TAIPEI CITY (TW); WEN-BIN CHEN, TAIPEI CITY (TW)

(21) Appl. No.: 15/642,633

(22) Filed: Jul. 6, 2017

(30) Foreign Application Priority Data
May 3, 2017 (TW) 106206195

(51) Int. Cl. H05B 37/02; H02J 7/00

(52) U.S. Cl. CPC H05B 37/0272; H02J 2007/0059; H02J 7/0052; H02J 7/0047

(57) ABSTRACT

The instant disclosure provides a wall switch base of an electric light including an electronic switch connected in series with the electric light and a switch base connected to the electronic switch. The electronic switch includes an AC/DC converting module, a charging module, a battery module and a wireless transmission module. The AC/DC converting module is configured to convert an alternating current into a direct current for output. The charging module is electronically connected to the AC/DC converting module for converting the received direct current into charging voltage. The battery module is electrically connected to the charging module for storing and supplying power. The wireless transmission module is electrically connected to the battery module for being operated based on the power provided by the battery module and controlling the electronic switch according to a received wireless control signal.

### BACKGROUND

### 1. Technical Field

The instant disclosure relates to a wall switch base of an electric light, and in particular, to a wall switch base of an electric light with a built-in battery module.

### 2. Description of Related Art

With the development of technology, wireless control of electric lights has become popular. In the existing art, a Bluetooth module is generally disposed in a wall switch base of an electric light, and the alternating current provided by the live wire is converted into direct current for powering the Bluetooth module. Since the power consumption of the Bluetooth module is low, the Bluetooth module can be operated based on the power directly provided by the live wire. However, a WIFI module has a relatively high power consumption and generates heat when powered.

Therefore, in order to overcome the disadvantage mentioned above, the design of a wall switch base of an electric light must be improved.

### SUMMARY

The main object of the instant disclosure is to provide a wall switch base of an electric light for solving the problem above.

An embodiment of the instant disclosure provides a wall switch base of an electric light including an electronic switch connected in series with the electric light and a switch base electrically connected to the electronic switch. The switch base includes an AC/DC converting module for converting an alternating current into a direct current for output, a charging module electrically connected to the AC/DC converting module for converting the direct current received from the AC/DC converting module into a charging voltage for output, a battery module electrically connected to the charging module for storing and supplying power, and a wireless transmission module electrically connected to the battery module for being operated based on power supplied by the battery module and controlling the electronic switch based on a wireless controlling signal.

To sum up, the wall switch base of an electric light provided by the instant disclosure includes a built-in battery module which is electrically connected to a wireless transmission module, and hence, the wireless transmission module with high power consumption can be operated based on power provided by the battery module. Therefore, the wireless transmission module receives stable power supplied from the battery module instead of receiving power from the live wire.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 is an external schematic view of the wall switch base of an electric light provided by the instant disclosure.

FIG. 2 is a structural schematic view of the wall switch base of an electric light provided by the instant disclosure.

FIG. 3 is a detailed structural schematic view of the wall switch base of an electric light provided by the instant disclosure.

### DESCRIPTION OF THE EXEMPLARY EMBODIMENTS

Reference will now be made in detail to the exemplary embodiments of the instant disclosure, examples of which are illustrated in the accompanying drawings. Wherever possible, the same reference numbers are used in the drawings and the description to refer to the same or like parts.

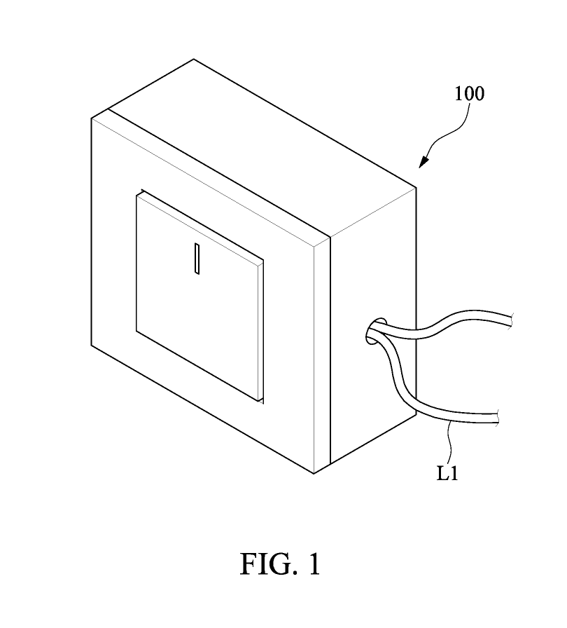

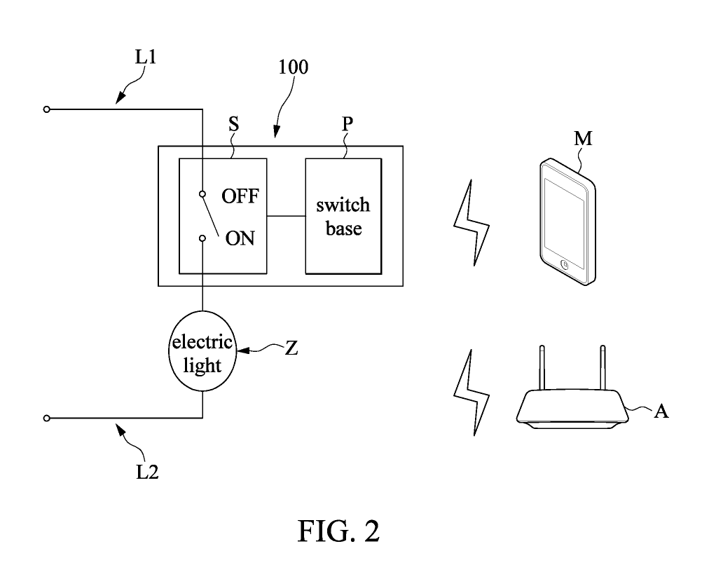

Reference is made to FIG. 1 to FIG. 3. The instant disclosure provides a wall switch base of an electric light 100. The wall switch base of the electric light 100 includes an electronic switch S connected in series with the electric light Z and a switch base P electrically connected to the electronic switch S.

The electric light Z has two ends connected to a first wire L1 and a second wire L2 respectively. The first wire L1 can be a live wire or a neutral wire, and the second wire L2 can be a neutral wire or a live wire. In the present embodiment, the first wire L1 is a live wire and the second wire L2 is a neutral wire. One end of the electric light Z is connected to the live wire and the other end of the electric light Z is connected to the neutral wire. The electronic switch S can be used to control the on and off of two ends of the live wire.

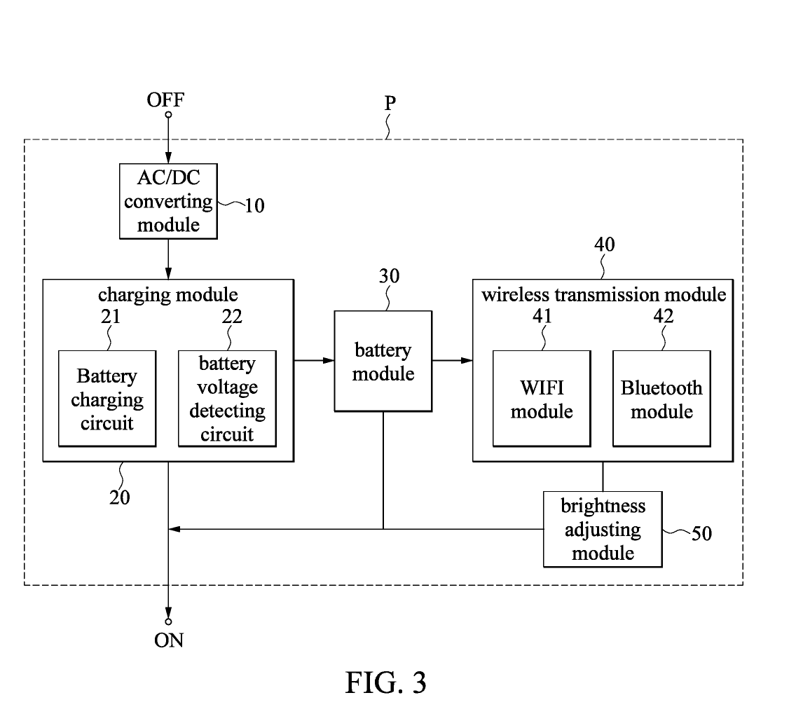

The switch base P is electrically connected to the electronic switch S and can be connected parallel with the electronic switch S. As shown in FIG. 3, the switch base P includes an AC/DC converting module 10, a charging module 20, a battery module 30 and a wireless transmission module 40. The switch base P can further include a brightness adjusting module 50.

The AC/DC converting module 10 can be an AC-DC converting circuit or module, and the AC/DC converting module 10 can obtain an alternating current from the live wire and convert the alternating current into a direct current. For example, the AC/DC converting module 10 can convert an alternating current of 220V or 110V into a direct current for output. The AC/DC converting module 10 can include a transformer, a rectifier or a filter, etc.

The charging module 20 can be a charger IC and is electrically connected to the AC/DC converting module 10. The charging module 20 can receive direct current from the AC/DC converting module 10 for converting the direct current into charging voltage for output. Specifically, the charging module 20 can include a battery charging circuit 21 and a battery voltage detecting circuit 22. The battery charging circuit 21 is configured to charge the battery module 30. The battery voltage detecting circuit 22 is configured to detect the voltage of the battery module 30, and when the voltage of the battery module 30 is lower than a predetermined voltage, the battery voltage detecting circuit 22 controls the battery charging circuit 21 to charge the battery module 30.

The battery module 30 can be a chargeable battery module and is electrically connected to the charging module 20 for storing and supplying electrical power. Specifically, the battery module 30 can have one or a plurality of lithium-ion batteries for receiving the charging voltage output by the charging module 20. Therefore, the charging module 20 can charge the battery module 30. For example, when the voltage of the battery module 30 detected by the charging module 20 is lower than 3V, the battery module 30 is pre-charged; when the voltage of the battery module 30 detected by the charging module 20 is between 3V and 4.2V, the battery module 30 is charged under a constant current; and when the voltage of the battery module 30 detected by the charging module 20 is larger than 4.2V the battery module 30 is charged under a constant voltage until the battery module 30 is full-charged.

The wireless transmission module 40 is electrically connected to the battery module 30 and hence, the wireless transmission module 40 can be operated under (powered by) the power provided by the battery module 30. Therefore, the wireless transmission module 40 does not need to consume the power provided by the live line. The wireless transmission module 40 can be operated under electrical power provided stably by the battery module 30. In addition, the wireless transmission module 40 can be configured to control the electronic switch S based on a received wireless control signal. Specifically, the wireless transmission module 40 can include a WIFI module 41 and/or a Bluetooth module 42 which can be operated separately and can be used to receive control signals. The wireless control signals can come from a portable device M such as a mobile phone or a tablet. In addition, the wireless control signal can come from a wireless access point A (WIFI AP). The portable device M can connect to the wireless transmission module 40 through the wireless access point A. Based on the design of the wireless transmission module 40, the wall switch base of the electric light 100 can be connected to the portable device M in wireless form, and when the wireless control signal output by the portable device M is corresponded to a control demand of “on”, the electronic switch S can be used to set the on/off state of the live line to be “on”. When the wireless control signal output by the portable device M is corresponded to a control demand of “off”, the electronic switch S can be used to set the on/off state of the live line to be “off”. Therefore, the on/off state of the electric light Z can be controlled by controlling the on and off the live line.

The brightness adjusting module 50 is electrically connected to the wireless transmission module 40. The brightness adjusting module 50 can adjust the output brightness of the electric light Z according to the wireless control signal received by the wireless transmission module 40. The brightness adjusting module 50 can be a PWM (Pulse Width Modulation) brightness adjusting module for adjusting the output brightness of the electric light Z according to the duty cycle of the PWM signal.

In summary, the wall switch base of the electric light 100 provided by the embodiments of the instant disclosure includes a built-in battery module 30 which is electrically connected to the wireless transmission module 40. Therefore, a high power consumption wireless transmission module 40 can be operated under power provided by the battery module 30 rather than power directly provided by the live line.

The above-mentioned descriptions represent merely the exemplary embodiment of the present disclosure, without any intention to limit the scope of the instant disclosure thereto. Various equivalent changes, alterations or modifications based on the claims of the instant disclosure are all consequently viewed as being embraced by the scope of the instant disclosure.

What is claimed is:

1. A wall switch base of an electric light, including:
an electronic switch connected in series with the electric light and a switch base electrically connected to the electronic switch, the switch base including:
an AC/DC converting module for converting an alternating current into a direct current for output;
a charging module electrically connected to the AC/DC converting module for converting the direct current received from the AC/DC converting module into a charging voltage for output;
a battery module electrically connected to the charging module for storing and supplying power; and
a wireless transmission module electrically connected to the battery module for being operated based on power supplied by the battery module and controlling the electronic switch based on a wireless controlling signal.

2. The wall switch base of an electric light according to claim 1, wherein the charging module includes a battery charging circuit and a battery voltage detecting circuit, the battery charging circuit being configured to charge the battery module, the battery voltage detecting circuit being configured to detect a voltage of the battery module; and when the voltage of the battery module is lower than a predetermined voltage, the battery voltage detecting circuit controls the battery charging circuit to charge the battery module.

3. The wall switch base of an electric light according to claim 1, wherein the wireless transmission module includes a WIFI unit or a Bluetooth unit for receiving the wireless control signal.

4. The wall switch base of an electric light according to claim 1, wherein two ends of the electric light are connected to a first wire and a second wire respectively.

5. The wall switch base of an electric light according to claim 4, wherein the first wire is a live wire and the second wire is a neutral wire, and the electronic switch is configured to control the on and off of the live wire.

6. The wall switch base of an electric light according to claim 1, wherein the wall switch base is wirelessly connected to a portable device, the portable device being configured to emit the wireless control signal.

7. The wall switch base of an electric light according to claim 3, wherein the WIFI unit can work independently based on power provided by the battery module.

8. The wall switch base of an electric light according to claim 3, wherein the Bluetooth unit can work independently based on power provided by the battery module.
